(19) United States
(12) Patent Application Publication
(10) Pub. No.: US 2008/0302861 A1
(43) Pub. Date: Dec. 11, 2008

(54) Method and apparatus for wave soldering an electronic substrate

(76) Inventors: Richard A. Szymanowski, Eldridge, MO (US); Kenneth R. Kirby, Kansas City, MO (US)

Correspondence Address: LOWRIE, LANDO & ANASTASI, LLP, ONE MAIN STREET, SUITE 1100, CAMBRIDGE, MA, 02142, US

(21) Appl. No.: 11/811,573

(22) Filed: Jun. 11, 2007

(51) Int. Cl. B23K 1/20; B23K 1/00; B23K 31/02

(52) U.S. Cl. 228/223; 228/37

(57) ABSTRACT

A wave soldering apparatus includes a solder supply and a first wave soldering nozzle in fluid communication with the solder supply. The first wave soldering nozzle includes a flat plate having a plurality of square-shaped openings formed therein to generate a first solder wave. An inert system is configured to deliver an inert gas around the first solder wave. Other embodiments and methods of wave soldering are further disclosed.

### BACKGROUND OF INVENTION

1. Field of Invention

This application relates generally to the surface mount of electronic components onto an electronic substrate, which is sometimes referred to as a printed circuit board or a printed wiring board assembly, by employing a wave soldering apparatus, and more particularly to a wave soldering nozzle that is designed to improve soldering efficiency and reduce defects.

2. Discussion of Related Art

Generally speaking, in a wave soldering machine, an electronic substrate is moved by conveyor on an inclined path past a fluxing station, a preheating station, and, finally, a station at which at least one wave of solder is caused to well upwardly and contact various portions of the electronic substrate to be soldered. With current wave soldering apparatus and methods, the advent of lead-free solders has led to reduced process yields and increased process costs. The ability of currently available equipment and process techniques to accommodate lead-free solders and newer and more challenging products, regardless of the solder alloy, is limited. Specifically, fundamental to the entire electronics manufacturing industry is the requirement to make a series of electrical connections, with a solder alloy, thereby creating an electrical circuit, and with final assembly, a functional device. The industry norm for over 40 years has been to use a tin-lead alloy solder, to make those electrical connections. Most recently, the use of tin-lead solder is being replaced by the use of lead-free alloys. Often, that alloy change is mandated by international legislation.

The effect has been a widespread change across all soldering, to include wave soldering, to using the lead-free solder alloys. With lead-free solders, existing wave soldering apparatus and methods are slower, with more production defects, and there is concern that the current art will foster less reliable product and latent field failures. As a related problem, when more defects are made at primary assembly, there is more cost and a quality concern associated with those repaired items. The efficiency and total cost associated with current wave soldering techniques is further limited by the thermal constraints in soldering fluxes, the pieces and parts being soldered, in addition to more difficult product designs.

With lead-free soldering, current art wave soldering machines and processes have difficulty in overcoming the fundamental lead-free alloy attributes of a higher melting temperature and slower wetting speeds. In many applications, these attributes are the root cause problem to the limitations noted. These alloy limitations cannot be addressed simply with chemistry or higher soldering temperatures because the electronic substrate cannot survive those conditions. While a logical solution would be to design more compatible electronic substrate, the industry has actually emphasized the opposite, creating new products that are more difficult to solder in any manner. For new lead-free solder materials used in wave soldering applications, there is a need for increased reliability, cost control, and the enhancement of operational environment in a mass-production factory.

### SUMMARY OF INVENTION

An aspect of the invention is directed to a wave soldering apparatus comprising a solder supply and a first wave soldering nozzle in fluid communication with the solder supply. The first wave soldering nozzle includes a flat plate having a plurality of square-shaped openings formed therein to generate a first solder wave. An inert system is configured to deliver an inert gas around the first solder wave.

Embodiments of the wave soldering apparatus may include configuring the plurality of square-shaped openings with rounded corners. The flat plate may be configured to have a widthwise dimension of approximately seven centimeters. The wave soldering apparatus may further comprise a second soldering nozzle configured to create a second solder wave, a flux application station and/or a preheat station.

Another aspect of the invention is directed to a wave soldering apparatus comprising a solder supply and a first wave soldering nozzle in fluid communication with the solder supply. The first wave soldering nozzle includes a flat plate having a plurality of openings and a widthwise dimension of approximately seven centimeters formed therein to generate a first solder wave. An inert system is configured to deliver an inert gas around the first solder wave.

Embodiments of the wave soldering apparatus may include configuring the plurality of openings to be square-shaped with rounded corners. The wave soldering apparatus may further comprises a second soldering nozzle configured to create a second solder wave, a flux application station and/or a preheat station.

Yet another aspect of the invention is directed to a wave soldering nozzle configured to create a solder wave. The wave soldering nozzle comprises a flat plate having a plurality of square-shaped openings and a widthwise dimension of approximately seven centimeters formed therein.

A further aspect of the invention is directed to a method of wave soldering electrical components to an electronic substrate. The method comprises: applying flux to an electronic substrate; preheating the electronic substrate; and moving the electronic substrate over a first wave soldering nozzle configured to generate a first solder wave of solder at a thickness depth of approximately 70% of a thickness of the electronic substrate.

Embodiments of the method of wave soldering may further comprise moving the electronic substrate over a second wave soldering nozzle configured to generate a second solder wave at a thickness depth of at least 40% a thickness of the electronic substrate. In one embodiment, flux is applied to the electronic substrate at a rate of less than 600 micrograms of flux solids per square inch of the electronic substrate. In another embodiment, the electronic substrate is preheated to a temperature of approximately 100° C. In yet another embodiment, the step of moving the electronic substrate over a first wave soldering nozzle takes place within a substantially inert atmosphere, e.g., less than 500 ppm O₂.

Another aspect of the invention is directed to a method of wave soldering electrical components to an electronic substrate. The method comprises: applying flux to an electronic substrate; preheating the electronic substrate; and moving the electronic substrate over a first wave soldering nozzle configured to create a solder wave. The wave soldering nozzle comprises a flat plate having a plurality of square-shaped openings and a widthwise dimension of approximately seven centimeters formed therein.

Embodiments of the method of wave soldering may further comprise moving the electronic substrate over a second wave soldering nozzle configured to generate a second solder wave at a thickness depth of at least 40% a thickness of the electronic substrate. In one embodiment, flux is applied to the electronic substrate at a rate of less than 600 micrograms of flux solids per square inch of the electronic substrate. In another embodiment, the electronic substrate is preheated to a temperature of approximately 100° C. In yet another embodiment, the step of moving the electronic substrate over a first wave soldering nozzle takes place within a substantially inert atmosphere, e.g., less than 500 ppm O₂.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a perspective view of a wave soldering apparatus embodying features of the invention;

FIG. 2 is a perspective view of a wave soldering solder station having a cover and a cover plate removed to illustrate a wave soldering nozzle of an embodiment of the invention;

FIG. 3 is a cross-sectional view taken along line 3-3 in FIG. 2 with the cover and cover plate provided;

FIG. 4 is a perspective view of the wave soldering nozzle shown in FIG. 2;

FIG. 5 is a top plan view of the wave soldering nozzle shown in FIGS. 2 and 4; and

FIG. 6 is a diagram showing a method of an embodiment of the invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

Generally speaking, wave soldering incorporates a wave soldering machine in which molten solder is pumped up to form at least one standing wave while electronic substrates are passed over the wave, thereby forming many solder joints that are uniform. Such wave soldering machines are designed to perform soldering operations at a high efficiency. The wave soldering machine automatically transports electronic substrates across required process steps to make solder joints, which includes a flux application station, a preheat station, and soldering station. In certain aspects, the invention is focused on improvements in the soldering station of the wave soldering machine, along with a combination of process soldering steps. The invention improves on the efficiency of wave solder machines, especially for, but not limited to, when using lead-free solder alloy. However, it should be understood that a person having ordinary skill in the art, given the benefit of this disclosure, may apply the principles taught herein in processes using lead-based solder materials.

The invention is directed to a dual wave soldering system in which a first wave soldering nozzle has an extended length that is parallel to the travel of the electronic substrate, e.g., a printed circuit board (“PCB”) or a printed wiring board assembly (“PWBA”). Unlike prior art nozzles, the first wave soldering nozzle includes a plate having an extended surface having a plurality of openings that are square with radius corners. The dual wave soldering system includes a second wave soldering nozzle of typical construction to create a smooth solder wave. The first and second wave soldering nozzles of the dual wave soldering system are contained within an enclosure to provide a reduced oxygen atmosphere, which is under 500 ppm O₂, and preferably under 100 ppm O₂, thereby preventing the formation of solder oxides in the molten metal. The first wave soldering nozzle and the method of wave soldering enables an operator of the dual wave soldering system to control the soldering atmosphere, significantly changing the soldering effect of the first wave soldering nozzle, thereby reducing the work content of the second wave soldering nozzle. Thus, by employing the principles taught herein, improved quality of the attachment of electronic components onto the electronic substrate and reduced costs may be achieved.

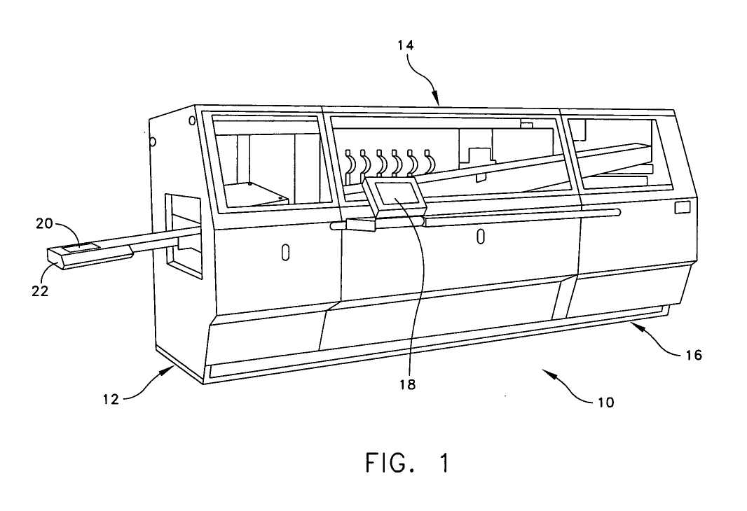

Referring now to the drawings, and more particularly to FIG. 1, there is generally indicated at 10 a wave soldering apparatus of an embodiment of the invention. As shown, the wave soldering apparatus includes three working stations, namely, a flux application station generally indicated at 12, a preheat station generally indicated at 14, and a wave soldering station generally indicated at 16. A controller having an operation monitor 18 controls the operation of the wave soldering apparatus 10 in the well-known manner. As shown, an electronic substrate 20 is moved by a conveyor 22 along an inclined path past the flux application station 12, the preheating station 14, and, finally, the wave soldering station 16. At the flux station 12, a soldering flux is applied to the surface of the electronic substrate 20 to be soldered. In a certain embodiment, the soldering flux contains less than ten percent solids and more than five percent solids contents. Examples of soldering fluxes include but are not limited to 2220-VF and 959 soldering fluxes provided by Kester of Itasca, Ill. and EF-6100 soldering flux provided by Alpha Metals of Jersey City, N.J. Soldering flux may be deposited at a rate of less than 600 micrograms of flux solids per square inch of surface area of the electronic substrate. At the preheat station 14, the electronic substrate is preferably heated to approximately 100° C. At the wave soldering station 16, as will be described in greater detail below, two solder waves (not shown in FIG. 1) are caused to well upwardly and contact various portions of the electronic substrate to be soldered.

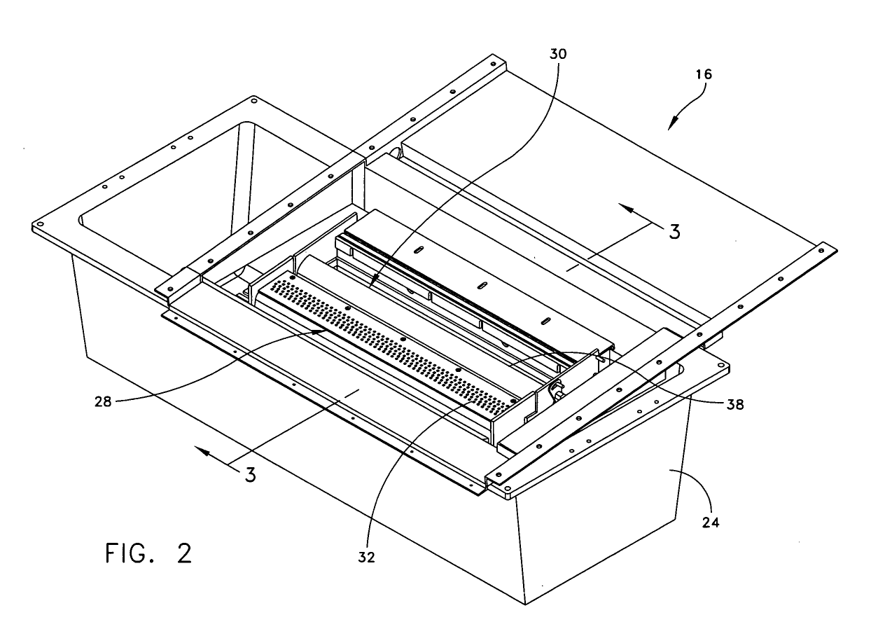

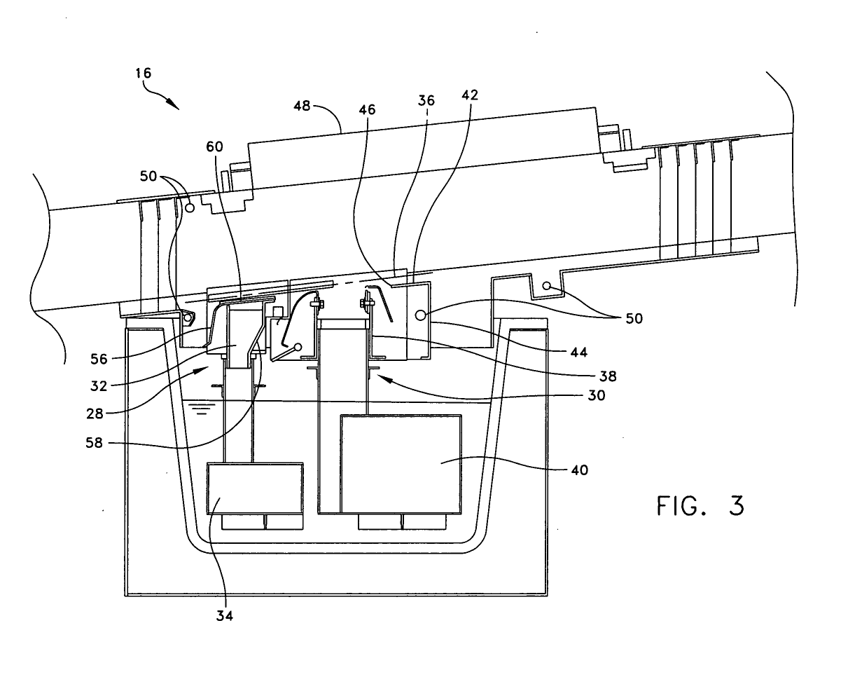

Referring to FIGS. 2 and 3, a wave soldering station 16 is shown apart from the rest of the wave soldering apparatus 10. As shown, the wave soldering station 16 includes a solder reservoir 24 that contains a supply of molten solder 26, a first wave soldering nozzle assembly generally indicated at 28, and a second wave soldering nozzle assembly generally indicated at 30. In the art, the solder reservoir 24, and even the wave soldering station 16 in general, may sometimes be broadly referred to as a “solder pot.” Although two wave soldering assemblies 28, 30 are illustrated, the principles taught herein may be applied to wave soldering machines incorporating only one wave soldering assembly, which produces a single rather than a dual wave.

As shown best in FIG. 3, the first and second nozzle assemblies 28, 30 are disposed within the solder reservoir 24. As shown, the first wave soldering nozzle assembly 28 includes a first solder nozzle 32 that extends up above solder 26 contained within the solder reservoir 24 and a first pump 34 that pumps solder up through the first solder nozzle to form a first solder wave having a height defined by centerline 36. Similarly, the second wave soldering nozzle assembly 30 includes a second solder nozzle 38 that extends up above solder 26 contained within the solder reservoir 24 and a second pump 40 that pumps solder up through the second solder nozzle to form a second solder wave having a height defined by the same centerline 36. An electronic substrate 20, such as a printed circuit board or a printed wiring board assembly, passes along the conveyor 22 so that at least a portion of the electronic substrate passes through the first and second solder waves in the manner described below. As is known, the solder waves are arranged to only contact the underside of the electronic substrate; however, the heights of the solder waves can be adjusted by varying the operation of the solder pumps 34, 40 to suit the different soldering requirements.

In certain embodiments, a vibrator plate (not shown), may be attached to each solder nozzle to provide an oscillation or vibration to the respective solder waves during the passage of the electronic substrate therethrough. The oscillation or vibration aids in filling or wicking up into small holes in the electronic substrates. Crevices and corners adjacent to a solder mask are also solder wetted, as well as all other areas where solder wetting is difficult to achieve by conventional machines.

Still referring to FIG. 3, a cover plate 42 is shown over the top of the solder reservoir 24. As shown in FIG. 3, the cover plate 42 has skirts, each indicated at 44, which extend around the perimeter of the cover plate and extend down into the solder reservoir to provide a seal thus providing a contained space under the cover plate. Brackets (not shown) may be provided to support the cover plate 42 on the sides of the solder reservoir 24. The cover plate 42 has a longitudinal slot 46 that extends along the solder waves and provides an aperture through which the solder waves project. A supply of gas may be supplied in the manner described below if necessary to ensure that the slot 46 at the ends has gas flowing out to blanket the ends as well as the sides of the solder wave. A cover 48 is provided above the cover plate 42 to provide a completely enclosed space above the solder waves. The cover 48 may be configured to provide access to the top of the wave soldering station 16, e.g., by means of a door or removable cover.

Gas pipes, each indicated at 50, are shown positioned on each side of the solder waves under the cover plate 42. The gas pipes 50 may be gas diffusers or, alternatively, may be pipes with holes therein. In certain embodiments, the gas pipes 50 are positioned as close to the solder waves as possible and in some instances the solder may touch or even flow over the gas pipes. Gas is supplied to the gas pipes 50 and the gas flows upwards through the slot 46 on the front side of the first solder wave and on the back side of the second solder wave, thus enveloping or blanketing the solder waves. When an electronic substrate 20 passes through the solder waves, the substrate forms a reaction wall and the gas not only covers the solder waves but also provides a canopy, which surrounds the substrate passing through the solder waves. In this manner the gas atmosphere blankets not only the surface of the solder reservoir 24 within the cover plate 42 but also blankets the surface of the solder wave and provides a canopy over electronic substrates passing through the solder waves.

In certain embodiments, the type of gas used to blanket the solder wave may be an inert gas, such as nitrogen, or a shield gas, a treatment gas, or a reducing gas may be used. In all cases oxygen is excluded from the space above the solder waves to achieve reliable soldering, and preferably to the smallest amount of oxidation possible. The gas may include additives, which are desirable for solder coating of wettable metallic surfaces or for joining at least two wettable metallic surfaces.

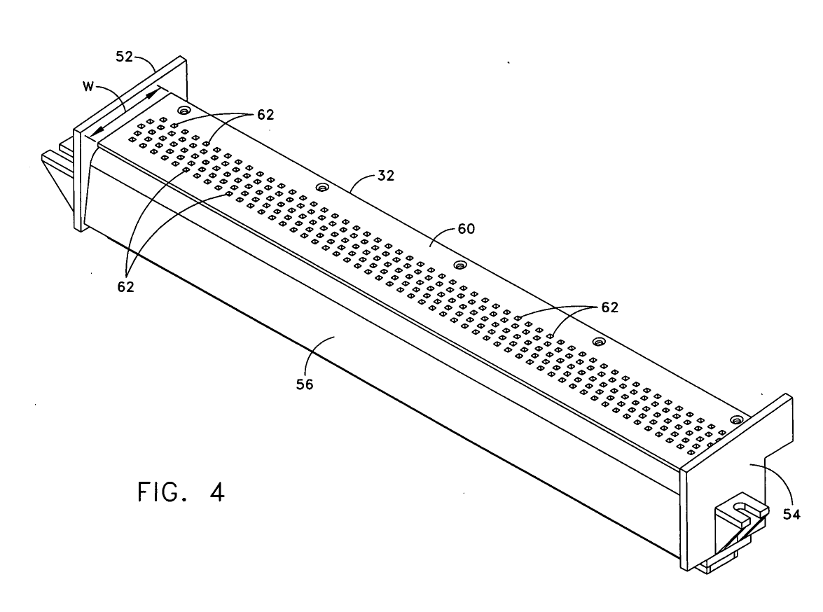

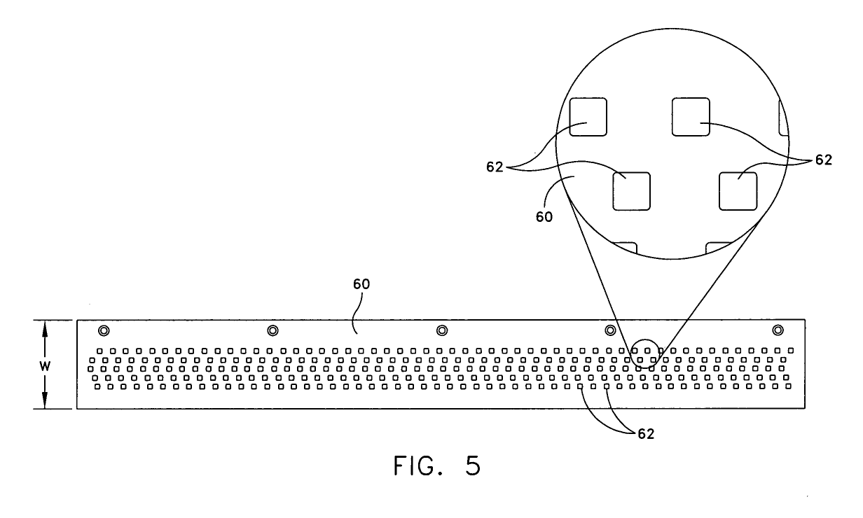

FIGS. 3 and 4 illustrate the first solder nozzle 32, which includes a housing having a left-hand side wall 52, a right-hand side wall 54, a front flange 56, a rear flange 58 (FIG. 3), and a flat top plate 60. In one embodiment, the flat top plate 60 has a plurality of square-shaped openings, each indicated at 62, formed therein to generate the first solder wave. As shown in FIG. 4 and in FIG. 5, the flat top plate 60 has a widthwise dimension W of at least 40 millimeters. Specifically, the flat top plate 60 has a widthwise dimension W of approximately seven centimeters, and in particular, 6.9 centimeters. The construction of the openings 62 formed in the top plate 60 is best shown in FIG. 5 in which each square-shaped opening has rounded corners. In one embodiment, each opening 62 has a widthwise dimension of approximately 3.3 millimeters. It should be understood that each opening 62 may be configured to be rectangular-shaped, for example, having slightly different dimensions. This construction enables the first wave soldering nozzle assembly 28 to generate a solder wave that is more turbulent than solder waves generated with prior art apparatus.

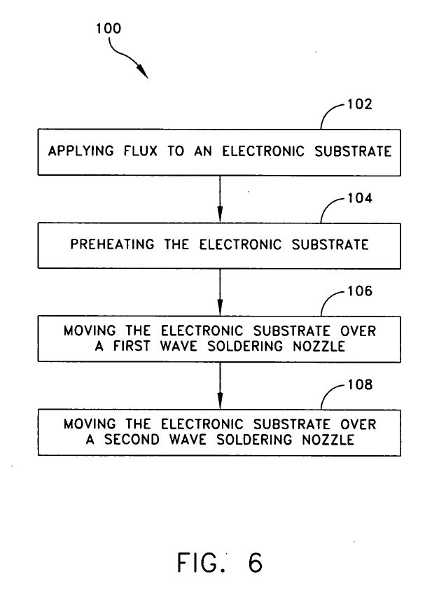

Turning now to FIG. 6, a method of wave soldering electrical components to an electronic substrate is generally indicated at 100. In a certain embodiment, the method 100 comprises: at step 102, applying flux to an electronic substrate; at step 104, preheating the electronic substrate; and at step 106, moving the electronic substrate over a first wave soldering nozzle configured to generate a first solder wave of solder at a thickness depth of approximately 70% of a thickness of the electronic substrate. As disclosed above, the first solder wave is created by the first nozzle having the top flat plate with square openings. In addition, the method may include at step 108 moving the electronic substrate over a second wave soldering nozzle configured to generate a second solder wave at a thickness depth of at least 40% a thickness of the electronic substrate. In one embodiment, flux may be applied to the electronic substrate at a rate of less than 600 micrograms of flux solids per square inch of the electronic substrate. In another embodiment, the electronic substrate may be preheated to a temperature of approximately 100° C. As disclosed above, the movement of the electronic substrates over the first and second nozzles takes place within a substantially inert atmosphere having less than 500 ppm O₂ and preferably less than 100 ppm O₂.

Thus, it should be observed that the principles disclosed herein teach a wave soldering system that will allow faster throughput speeds and lower defects when wave soldering, especially with lead-free solder. The apparatus and methods disclosed herein improve the wave solder capability to manufacture the newer and more challenging product designs.

In particular, the apparatus and methods disclosed herein will provide better quality of solder connections at a lower cost, without the addition of more assembly lines. Reduced defects and increased throughput create a short payback time for the customer investment in this system. In certain embodiments, employing the apparatus and methods disclosed herein may allow for an assembly line to maintain a higher production rate, where the current art would require as much as a 40% slow-down, which will reduce factory output and raise costs. In addition, an operator, when employing lead-free solder alloys, is able to manufacture a solder joint with reduction of defects. Also, cost savings are further realized in that less process materials are used. Specifically, less consumable materials are used in the wave soldering apparatus to make the same number of solder joints than in current art, thereby saving money in consumable materials, e.g., soldering flux and solder. When less material is used to make the same amount of product, there is also a reduction in the amount of labor and maintenance for the machine.

The wave soldering station of embodiments disclosed herein includes an enclosure that displaces the air away from the soldering area, to the range under 500 ppm O₂. In certain embodiments, there is less than 15 ppm O₂ in the soldering area. The wave soldering station includes two wave soldering nozzles, which create the molten wave of metal to the surface of the electronic substrate, to form the solder joints.

In one embodiment, the first wave soldering nozzle is an extended flat top plate with an array of square-shaped openings, through which molten solder is pumped, creating a very turbulent solder wave form that has exceptionally strong vertical force vectors and pressure. The square-shaped openings having radius corners not only provide strong solder pressure, but also resist becoming clogged. The first wave soldering nozzle extends parallel to the travel of the electronic substrate being soldered. This is contrasted to current nozzle designs, which utilize round or oval holes, is not of an extended length, nor is it extended parallel to the travel of the electronic substrate.

Adjacent to the first wave soldering nozzle is a second wave soldering nozzle that completes the soldering process with a smooth wave form. The second nozzle is constructed in the same manner as prior art dual wave soldering designs.

In another embodiment, a method of wave soldering electrical components to an electronic substrate includes controlling the atmosphere around the first and second wave soldering nozzles to having less than 500 ppm O₂, and preferably less than 100 ppm O₂ (e.g., 15 ppm O₂) at the point of making a solder joint must be maintained. The majority of the solder contact time and solder flow, which is required to create a complete solder joint is be almost completed while the electronic substrate is in contact with the first wave soldering nozzle. The electronic substrate may contact the solder wave formed by the second nozzle in less than 75 mm, where the minority of solder joints will be completed, and excess solder conditions will be controlled.

An aspect of the method may embody using a soldering flux that contains less than ten percent solids content and more than five percent solids content. The flux may be applied at a deposit rate of less than 600 micrograms of flux solids per square inch of board solder surface. A moderate preheat temperature may be employed to activate the flux and to preheat the electronic substrate, such as a temperature 100° C. below the melting point of solder. In one embodiment, the electronic substrate is immersed to a depth of approximately 70% of the thickness of the electronic substrate into the turbulent wave created by the first wave soldering nozzle. At the second solder wave, the electronic substrate is immersed to a depth of approximately 40% to 70% of the thickness of the electronic substrate into relatively smooth wave created by the second wave soldering nozzle.

By employing principles disclosed herein, the wave soldering station provides a reduced-oxygen atmosphere around the point of solder joint formation to eliminate the oxide layer on the solder. With the elimination of the oxide layer, the flow of solder is greatly improved. As a result, it is easier and faster to form a solder joint. The reduction of solder oxides also reduces the amount of suspended solder oxide particles in the molten solder bath, reducing random solder defects caused by particulate. In a certain embodiment, by controlling the atmosphere, the amount of solder alloy lost to oxide is reduced from about 550 grams per operating hour to approximately 35 grams per operating hour thereby providing added cost reduction to the system. Because soldering flux is required to clean all of the oxides that inhibit soldering, and the enclosure has already reduced the oxides in the machine, it is possible to use less flux material, which is another cost reduction. The use of less flux creates a more cosmetically acceptable product, and, it also reduces the problems caused by flux residues in following process steps.

In contrast with currently available dual wave soldering machines, the first wave soldering nozzle engages the electronic substrate for an extended period of time due to the wider top plate thus completing all or nearly all of the soldering required with the first nozzle. With current dual wave soldering machines, it is unusual for near complete solder joints to be formed on the entire assembly at the first solder nozzle.

The provision of square-shaped openings in the first wave soldering nozzle assist in providing strong solder pressure, strong vertical impingement forces against the electronic substrate, and high thermal energy transfer, with minimal aperture clog. This means that the wave soldering machine of embodiments disclosed herein has better hole-fill, fewer missed solder joints and will solder more thermally challenging product, for a longer period of time than the prior practice. In certain embodiments, the maximum improvement over prior practice is near 30%.

The methods disclosed herein change the sequence of soldering events, making the first wave soldering nozzle, not the second wave soldering nozzle, where the complete solder joint is formed. It also applies the advantages of a controlled atmosphere, which means that better quality and faster production run rates are realized than with the prior practice. In a production environment, the use of current art would translate to a need for more capital equipment, floor space and staff. This would also increase overhead costs, with slower payback on the original art equipment.

Associated to the improved process quality, the amount of repair work after the wave soldering process step is reduced. Not only is this an immediate cost reduction from time and effort, but the potential of latent field failure and scrap is further reduced.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A wave soldering apparatus comprising:
a solder supply;
a first wave soldering nozzle in fluid communication with the solder supply, the first wave soldering nozzle including a flat plate having a plurality of square-shaped openings formed therein to generate a first solder wave; and
an inert system configured to deliver an inert gas around the first solder wave.

2. The apparatus of claim 1, wherein the plurality of square-shaped openings each have rounded corners.

3. The apparatus of claim 1, wherein the flat plate has a widthwise dimension of approximately seven centimeters.

4. The apparatus of claim 1, further comprising a second soldering nozzle configured to create a second solder wave.

5. The apparatus of claim 4, further comprising a flux application station.

6. The apparatus of claim 5, further comprising a preheat station.

7. A wave soldering apparatus comprising:
a solder supply;
a first wave soldering nozzle in fluid communication with the solder supply, the first wave soldering nozzle including a flat plate having a plurality of openings and a widthwise dimension of approximately seven centimeters formed therein to generate a first solder wave; and
an inert system configured to deliver an inert gas around the first solder wave.

8. The apparatus of claim 7, wherein each opening of the plurality of openings are square-shaped with rounded corners.

9. The apparatus of claim 7, further comprising a second soldering nozzle configured to create a second solder wave.

10. The apparatus of claim 9, further comprising a flux application station.

11. The apparatus of claim 10, further comprising a preheat station.

12. A wave soldering nozzle configured to create a solder wave, the wave soldering nozzle comprising a flat plate having a plurality of square-shaped openings and a widthwise dimension of approximately seven centimeters formed therein.

13. A method of wave soldering electrical components to an electronic substrate, the method comprising:
applying flux to an electronic substrate;
preheating the electronic substrate; and
moving the electronic substrate over a first wave soldering nozzle configured to generate a first solder wave of solder at a thickness depth of approximately 70% of a thickness of the electronic substrate.

14. The method of claim 13, further comprising moving the electronic substrate over a second wave soldering nozzle configured to generate a second solder wave at a thickness depth of at least 40% a thickness of the electronic substrate.

15. The method of claim 13, wherein flux is applied to the electronic substrate at a rate of less than 600 micrograms of flux solids per square inch of the electronic substrate.

16. The method of claim 13, wherein the electronic substrate is preheated to a temperature of approximately 100° C.

17. The method of claim 13, wherein moving the electronic substrate over a first wave soldering nozzle takes place within a substantially inert atmosphere.

18. The method of claim 17, wherein the substantially inert atmosphere is less than 500 ppm O₂.

19. A method of wave soldering electrical components to an electronic substrate, the method comprising:
applying flux to an electronic substrate;
preheating the electronic substrate; and
moving the electronic substrate over a first wave soldering nozzle configured to create a solder wave, the wave soldering nozzle comprising a flat plate having a plurality of square-shaped openings and a widthwise dimension of approximately seven centimeters formed therein.

20. The method of claim 19, further comprising moving the electronic substrate over a second wave soldering nozzle configured to generate a second solder wave at a thickness depth of at least 40% a thickness of the electronic substrate.

21. The method of claim 19, wherein flux is applied to the electronic substrate at a rate of less than 600 micrograms of flux solids per square inch of the electronic substrate.

22. The method of claim 19, wherein the electronic substrate is preheated to a temperature of approximately 100° C.

23. The method of claim 19, wherein moving the electronic substrate over a first wave soldering nozzle takes place within a substantially inert atmosphere.

24. The method of claim 23, wherein the substantially inert atmosphere is less than 500 ppm O₂.
